(19) United States
(12) Patent Application Publication
(10) Pub. No.: US 2016/0203014 A1
(43) Pub. Date: Jul. 14, 2016

(54) MANAGING VIRTUAL MACHINES USING GLOBALLY UNIQUE PERSISTENT VIRTUAL MACHINE IDENTIFIERS

(71) Applicant: International Business Machines Corporaiton, Armonk, NY (US)

(72) Inventors: Michael Karl Gschwind, Chappaqua, NY (US); Richard E. Harper, Chapel Hill, NC (US); Valentina Salapura, Chappaqua, NY (US); Gerhard Widmayer, Herrenberg (DE)

(21) Appl. No.: 14/591,963

(22) Filed: Jan. 8, 2015

(51) Int. Cl. G06F 9/455

(52) U.S. Cl. CPC G06F 9/45558; G06F 2009/45562; G06F 2009/45575; G06F 2009/4557

(57) ABSTRACT

A method for identifying and managing a plurality of virtual machines is provided. The method may include creating a virtual machine within the plurality of virtual machines. The method may include creating a plurality of globally unique IDs for each virtual machine within the plurality of virtual machines. The method may also include assigning each of the globally unique IDs within the plurality of globally unique IDs to each of the virtual machines within the plurality of virtual machines, whereby the assigned globally unique ID is assigned to only one virtual machine. The method may include recording each globally unique ID into at least one database. The method may include associating the recorded globally unique ID with a management domain corresponding to the virtual machine assigned the globally unique ID, and a domain ID corresponding to the virtual machine.

### BACKGROUND

The present invention relates generally to the field of computers, and more particularly to managing virtual machines (VMs).

To identify, manage, and move Virtual machines (VMs), one needs to know a host and partition ID. An ID is an identifier. In a virtual environment, VMs are identified based on their ID, name and/or the server where the VMs are physically located or the path to the VM. A virtual machine control (VMC) tool controls a number of servers, such as in a cluster, and tracks all the servers and their VMs. As such, each of the VMs has an entry in the database and the VM is identified by the VM's unique ID, such as the object identifier OID which contains the identifier ID of the physical server. Higher management tools, such as IBM's Tivoli Service Automation Manager (TSAM), which provision new VMs and represent a user interface (UI) to the end user, use the OID to track the VMs. However, when a VM is moved from one server or cluster to another server or cluster, the OID number changes since the physical server where the VM is stored has changed, and therefore, the VMC and all other tools need to be informed of the change.

### SUMMARY

According to one embodiment, a method identifying and managing a plurality of virtual machines is provided. The method may include creating a virtual machine within the plurality of virtual machines. The method may also include creating a plurality of globally unique IDs for each virtual machine within the plurality of virtual machines. The method may further include assigning each of the globally unique IDs within the plurality of globally unique IDs to each of the virtual machines within the plurality of virtual machines, whereby the assigned globally unique ID is assigned to only one virtual machine. The method may also include recording each globally unique ID into at least one database. The method may include associating the recorded globally unique ID with a management domain corresponding to the virtual machine assigned the globally unique ID, and a domain ID corresponding to the virtual machine.

According to another embodiment, a computer system for identifying and managing a plurality of virtual machines is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include creating a virtual machine within the plurality of virtual machines. The method may also include creating a plurality of globally unique IDs for each virtual machine within the plurality of virtual machines. The method may further include assigning each of the globally unique IDs within the plurality of globally unique IDs to each of the virtual machines within the plurality of virtual machines, whereby the assigned globally unique ID is assigned to only one virtual machine. The method may also include recording each globally unique ID into at least one database. The method may include associating the recorded globally unique ID with a management domain corresponding to the virtual machine assigned the globally unique ID, and a domain ID corresponding to the virtual machine.

According to yet another embodiment, a computer program product for identifying and managing a plurality of virtual machines is provided. The computer program product may include one or more computer-readable storage devices and program instructions stored on at least one of the one or me tangible storage devices, the program instructions executable by a processor. The computer program product may include program instructions to create a virtual machine within the plurality of virtual machines. The computer program product may also include program instructions to create a plurality of globally unique IDs for each virtual machine within the plurality of virtual machines. The computer program product may further include program instructions to assign each of the globally unique IDs within the plurality of globally unique IDs to each of the virtual machines within the plurality of virtual machines, whereby the assigned globally unique ID is assigned to only one virtual machine. The computer program product may also include program instructions to record each globally unique ID into at least one database. The computer program product may include program instructions to associate the recorded globally unique ID with a management domain corresponding to the virtual machine assigned the globally unique ID, and a domain ID corresponding to the virtual machine.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to one embodiment;

FIGS. 2A-2B is an exemplary illustration of the persistent unique VM ID remaining unchanged according to at least one embodiment;

FIGS. 3A-3D are operational flowcharts illustrating the steps carried out by a program for managing VMs using persistent unique IDs according to at least one embodiment;

FIG. 4 is a block diagram of internal and external components of computers and servers depicted in FIG. 1 according to at least one embodiment;

FIG. 5 is a block diagram of an illustrative cloud computing environment including the computer system depicted in FIG. 1, in accordance with an embodiment of the present disclosure; and

FIG. 6 is a block diagram of functional layers of the illustrative cloud computing environment of FIG. 5, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

Embodiments of the present invention relate generally to the field of computers, and more particularly to managing VMs. The following described exemplary embodiments provide a system, method and program product to, among other things, provide a remote backup system (RBS) for managing VMs using persistent unique VM IDs. Additionally, the present embodiment has the capacity to improve the technical field of VM management by assigning a globally unique persistent identifier at creation of a VM that may be used by all management tools for the duration of the VM's lifetime. Furthermore, the present embodiment has the ability to track VMs with unique IDs and supporting management actions that allow a user to identify, locate, and manage a partition without regard to its current location.

As previously described, as a virtual machine is moved or migrated from one host (i.e., physical machine) to another within a cluster or if a VM needs to be recreated in a new data center as the result of a disaster recovery, all tracking information becomes invalid, and therefore, inconsistencies in the system and errors may easily occur which may make it become difficult or even impossible to track, manage or locate a VM. As such, a work around may be to utilize a specific management tool to figure out (using its own discovery mechanisms) whether or when a VM has been moved or even missing and update its own internal database (which may be referenced with a locally invariant ID that is not guaranteed to be universal) with the mapping to the local-dependent VM identifier. As a result, independent islands of management tools may exist which may react differently and on different time scales to VM moves. Furthermore, such an environment may become chaotic, especially when one management tool may depend on another and they both may have to compete for the same update for the entire stack to work properly. As such, it may be advantageous, among other things, to implement a method where a VM may be assigned a globally unique persistent identifier at creation and that ID may be intended to be used by all management tools for the duration of the VM's lifetime.

According to at least one implementation, the present embodiment may assign a globally unique identifier to a VM, propagating the globally unique ID to all managers or in an alternate implementation, storing the globally unique ID on a VM descriptor that may be available to all managers and as such, eliminating the need for the islands of management tools from actually having to perform locale-dependent tracking. Furthermore, such a persistent ID for each VM may enable a VM to be uniquely identified within a cluster, within a data center, and within multiple data centers. Such a globally unique ID may be extended to any attribute of the VM that is tied to the physical server. Additionally, the globally unique ID may be used by any software that may rely on an invariant ID, such as licensing software.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product to provide a global virtual machine management system for managing VMs using persistent globally unique VM IDs. Embodiments of the present invention may provide the ability to track the VMs with unique IDs regardless of the location. Furthermore, supporting management actions may allow for the identification, tracking, location, and management of the VMs. As such, once a VM is created, a globally unique persistent virtual object ID is assigned to the VM, stored in the database and then tracked through the use of the database. Additionally, the present embodiment may also enable the correlation of multiple virtual object IDs across management domains (e.g., a vsphere cluster or cluster of servers) to facilitate tracking.

According to at least one implementation of the present embodiment, each VM may receive a unique persistent ID (pID). The unique persistent ID may be provided at provisioning time and there may be different methods for creating the pID. The pID may be randomly generated, however it must still be globally unique. Alternatively, the pID may be created by combining server IDs (which themselves are virtual IDs) or the pID may be created based upon the host name (which can be made unique). As such, the VMC may use an additional field with the pID for each VM and then all other tools using the information from the VMC about the VMs may refer to the VM by its pID. An example of a VMC entry for a VM with a pID assigned to the VM may be illustrated as follows:

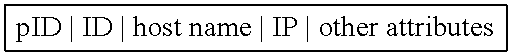

The present embodiment may enable a VM to be identified and not confused on the local device, in the cloud in a single data center, or across multiple data centers. For example, the present embodiment may be beneficial when migrating a VM within a data center from one server to another, either for live migration or for remote restart. Furthermore, another example of when such a persistent unique ID may be beneficial may be when a migration takes place between multiple data centers for disaster recovery. According to the present embodiment, the user and systems management tools may access the VM in the same way and see the same interface.

Various embodiments of the present specification may also allow for a path-independent VM identification. Currently, the VMC generates OIDs based on which hardware management console (HMC) it is using. As such, if the HMC fails, then new OIDs are discovered through a secondary HMC. The OID is a function of the path between the VM and the VMC management server and therefore, upper layers of the management data may become corrupted. However, according to the present embodiment, usage of a pID may allow for a path-independent identification of the VM and as such, disruption of the pID due to different paths may be avoided.

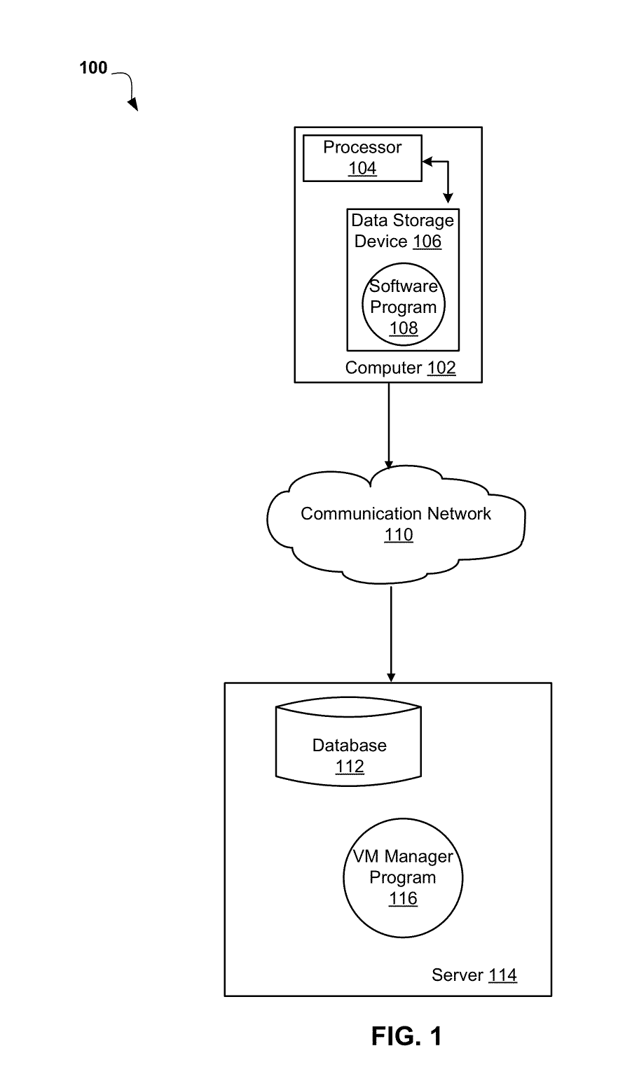

Referring to FIG. 1, an exemplary networked computer environment 100 in accordance with one embodiment is depicted. The networked computer environment 100 may include a computer 102 with a processor 104 and a data storage device 106 that is enabled to run a software program 108. The networked computer environment 100 may also include a server 114 that is enabled to run a VM Manager Program 116 that interacts with a database 112, and a communication network 110. The networked computer environment 100 may include a plurality of computers 102 and servers 114, only one of which is shown. The communication network may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

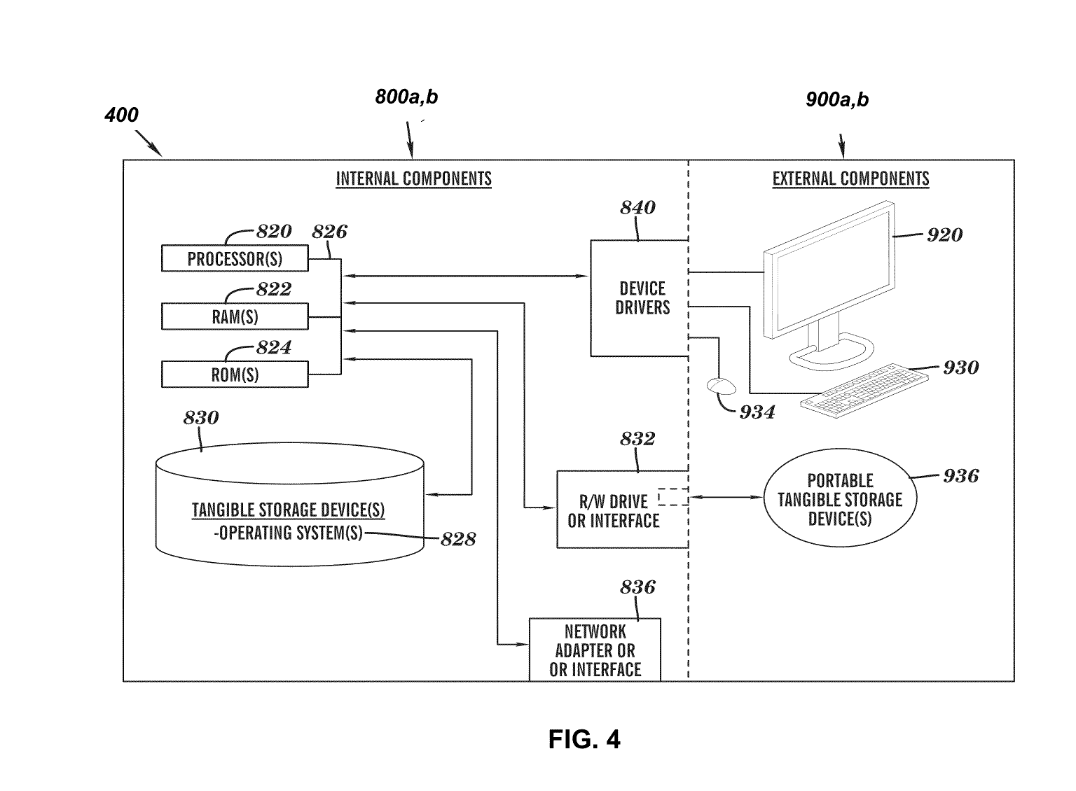

The client computer 102 may communicate with database 112 running on server computer 114 via the communications network 110. The communications network 110 may include connections, such as wire, wireless communication links, or fiber optic cables. As will be discussed with reference to FIG. 4, server computer 114 may include internal components 800a and external components 900a, respectively, and client computer 102 may include internal components 800b and external components 900b, respectively. Client computer 102 may be, for example, a mobile device, a telephone, a personal digital assistant, a netbook, a laptop computer, a tablet computer, a desktop computer, or any type of computing devices capable of running a program, accessing a network, and accessing a database 112.

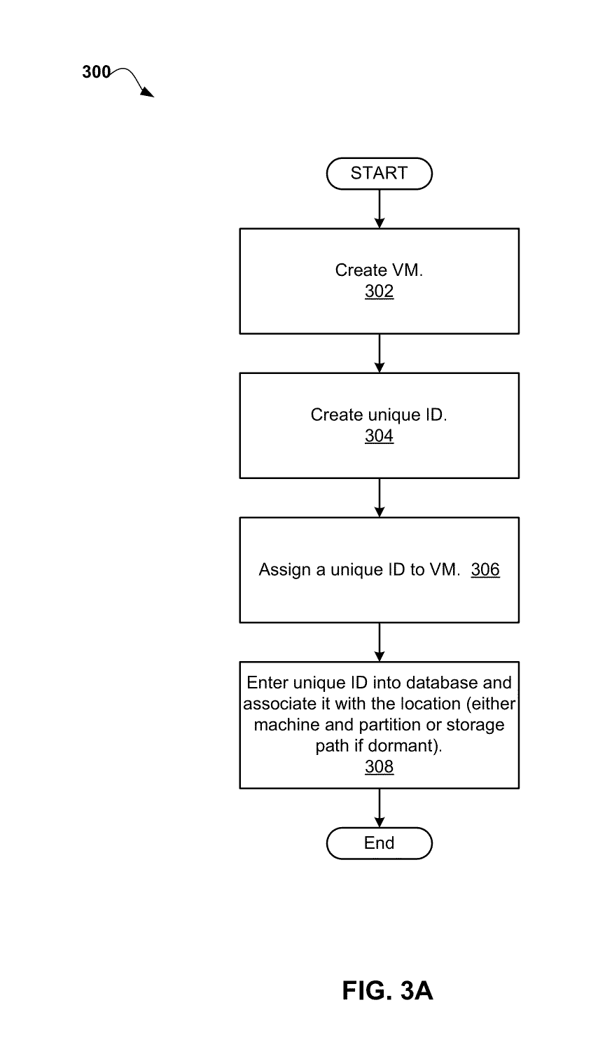

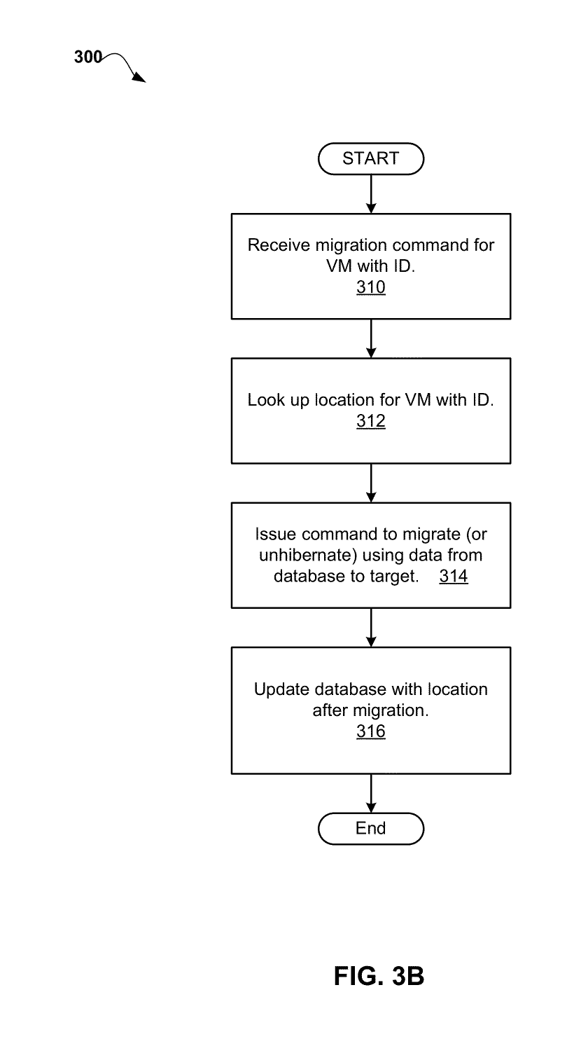

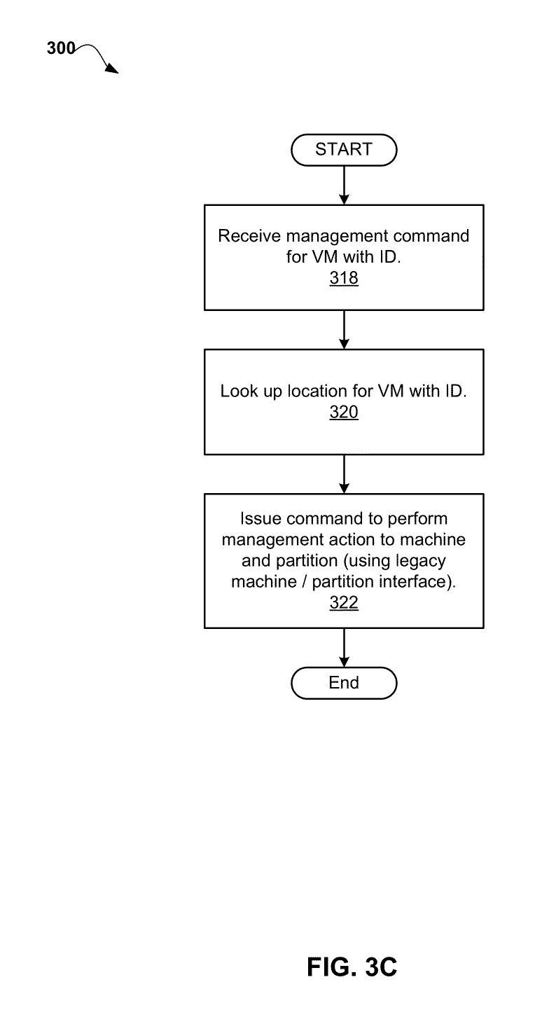

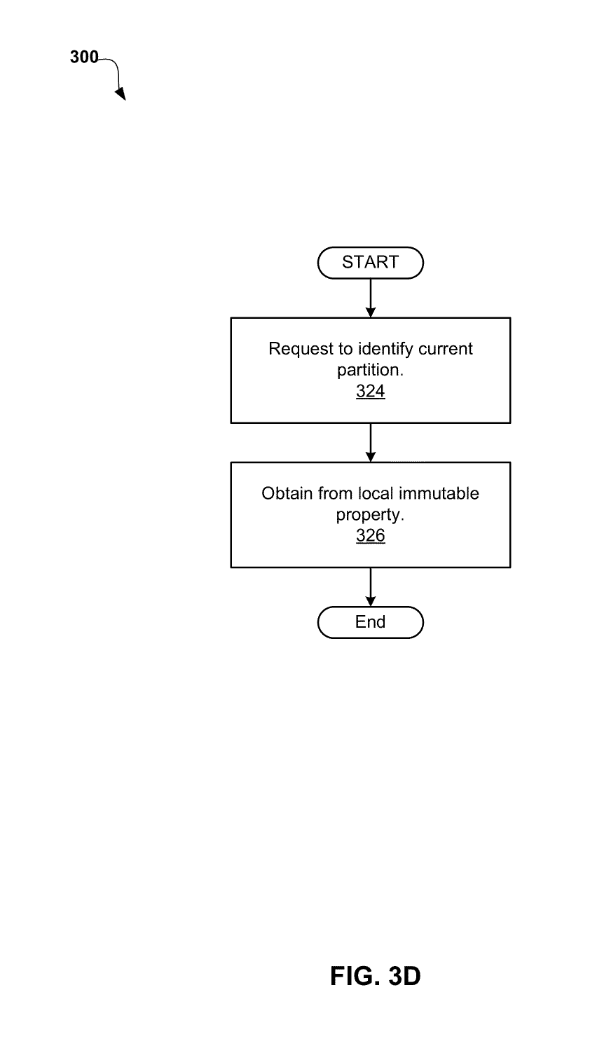

As previously described, the client computer 102 may access database 112 or the VM Manager Program 116, running on server computer 114 via the communications network 110. For example, a user using an application program 108 running on a client computer 102 may connect via a communication network 110 to database 112 or the VM Manager Program 116 which may be running on server computer 114. As previously described, the VM Manager program may provide a remote backup system (RBS) for managing VMs using persistent unique VM IDs. As such, the user may utilize the VM Manager Program 116 running on server 114 to track the VMs with unique IDs regardless of the location. The VM Manager Program 116 may allow for the identification, tracking, location, and management of the VMs by creating and storing a unique pID associated with a VM in a database 112. The VM Manager method is explained in more detail below with respect to FIGS. 3A-3D.

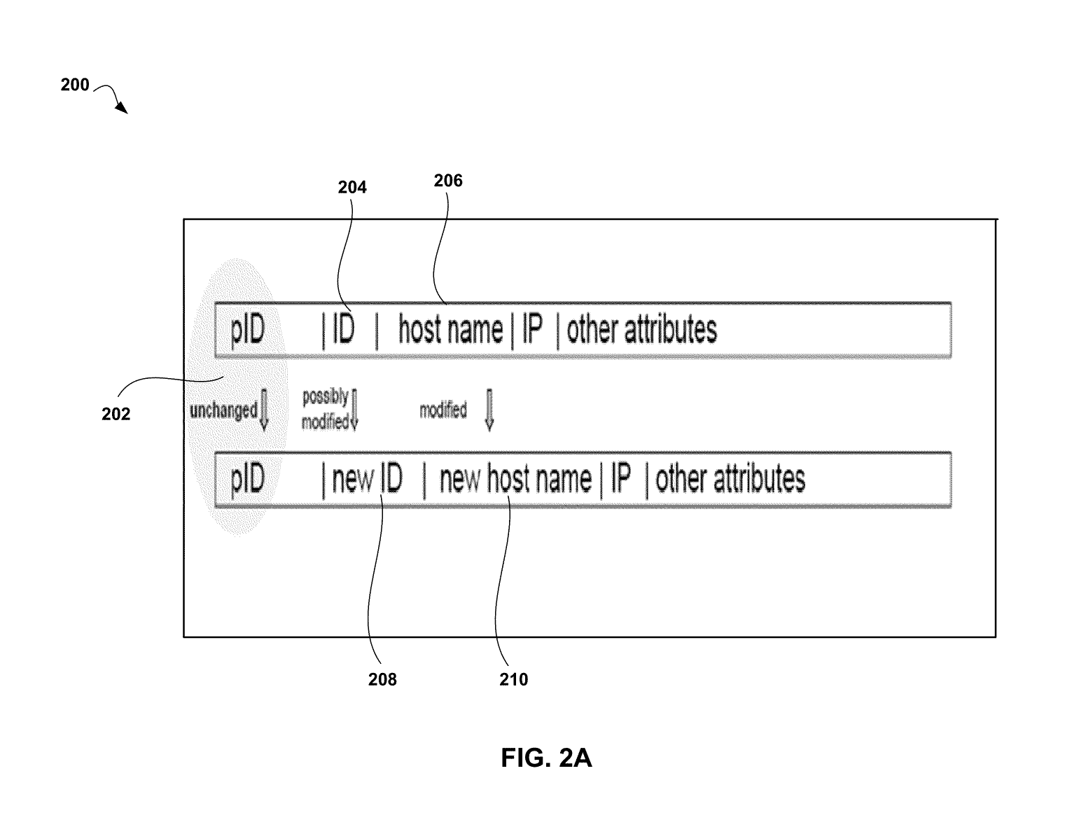

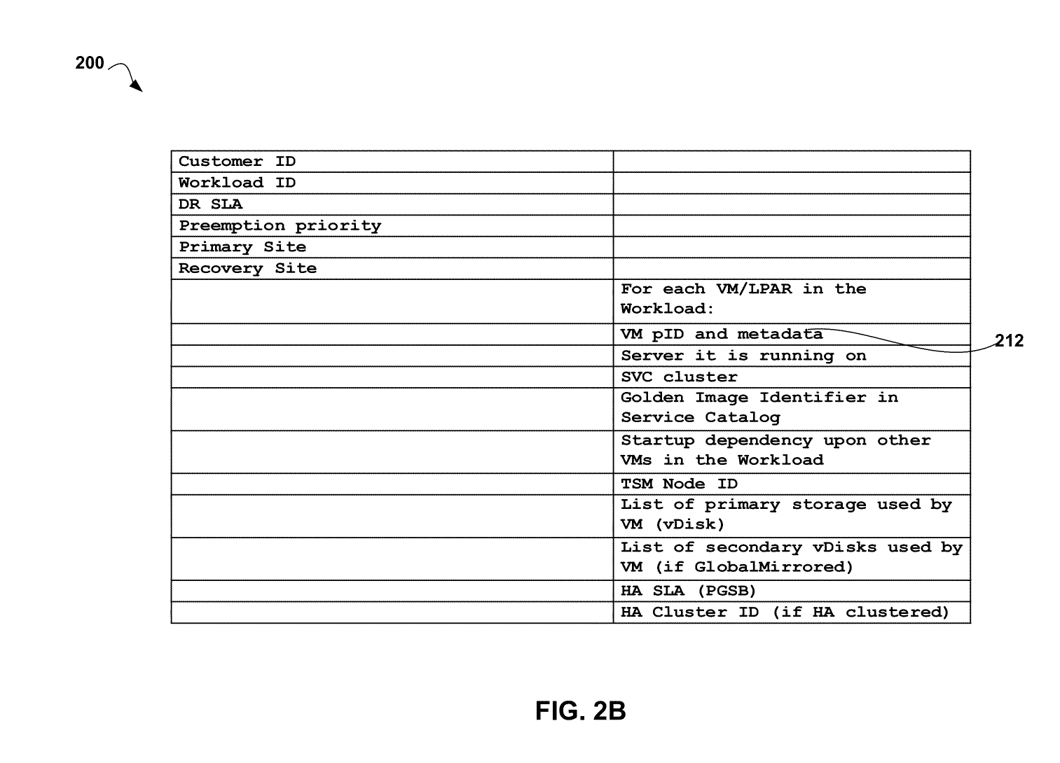

Referring now to FIGS. 2A-2B, an exemplary illustration 200 of the persistent unique VM ID remaining unchanged according to at least one implementation of the present embodiment is depicted. FIG. 2A illustrates an example of the pID remaining unchanged during a live migration and remote restart accordance with one embodiment. During a live migration, the VMC may initiate a live migration and then the destination server is determined. Next, the VMC will migrate the VM and then then the VMC will update the ID 204 and host name 206 associated with the VM with a new ID 208 and a new host name 210. However service management tool, such as TSAM (Tivoli Service Automation Manager) which enables users to request, deploy, monitor and manage cloud computing services may still refer to the same VM and all parameters are reachable since according to the present embodiment, the pID 202 has remained unchanged.

Similarly, on the remote restart, the VMC or the remote restart (RR) scripts initiate the remote restart and the destination server is determined. The VMC discovery will update the ID and host name, however TSAM may still refer to the same VM and all parameters are reachable since the pID 202 has remained unchanged.

FIG. 2B illustrates an example of disaster recovery metadata in accordance with one embodiment. During disaster recovery, disaster recovery orchestrator (DRO) determines the disaster recovery (DR) site and the destination server is determined in the DR site. Then the DRO restarts the VM on the DR site and the VMC creates a new VM with a new ID and host name, however according to the present embodiment, the pID 212 is unchanged. Having the pID 212 remain unchanged, may be critical to maintaining manageability after DR since TSAM and all upper management layers still refer to the same VM with the pID and as such, all parameters are reachable.

Referring now to FIGS. 3A-3D, an operational flowchart 300 illustrating the steps carried out by a program for managing VMs using persistent unique IDs according to at least one embodiment is depicted.

FIG. 3A illustrates the steps to create a VM and assign an ID according to at least one implementation. At 302, a VM is created. As such, the VM Manager Program 116 (FIG. 1) may create a VM within a group of VMs.

Then at 304, a unique ID is created. Therefore, the VM Manager Program 116 (FIG. 1) may create a globally unique ID for each virtual machine within the group of virtual machines. As previously described, the unique persistent ID (pID) may be provided at provisioning time and there may be different methods for creating the pID. The pID may be randomly generated, however it must still be globally unique. Alternatively, the pID may be created by combining server IDs (which themselves are virtual IDs) or the pID may be created based upon the host name (which can be made unique). As such, the VMC may use an additional field with the pID for each VM and then all other tools using the information from the VMC about the VMs may refer to the VM by its pID. Furthermore, according to at least one implementation, the VM Manager Program 116 (FIG. 1) may bind the globally unique ID (i.e., the pID) to an existing resource, such as an unused fibre channel port that is not reflective of the globally unique ID. Additionally, the globally unique ID may be assigned and queried in a legacy virtual machine environment that is not designed to support such assigning of a globally unique ID.

Next, at 306, the unique ID is assigned to the VM. As such, the VM Manager Program 116 (FIG. 1) may assign each of the globally unique IDs created within the group of globally unique IDs to each of the virtual machines within the group of virtual machines, whereby the assigned globally unique ID is assigned to only one virtual machine within the group.

Then at 308, the unique ID is entered into a database and the unique ID is associated with the location (either machine and partition, or storage path if it is a dormant VM). Therefore, the VM Manager Program 116 (FIG. 1) may record each globally unique ID into at least one database and associate the recorded globally unique ID with a location of the virtual machine assigned the globally unique ID. Additionally, the VM Manager Program 116 (FIG. 1) may record a management domain corresponding to the virtual machine assigned the globally unique ID and may also record a domain ID corresponding to the virtual machine assigned the globally unique ID.

FIG. 3B illustrates the steps performed during a migration action according to at least one implementation. At 310, a migration command is received for a VM with a globally unique ID. For example, a user may initiate a migration command request for a VM with a globally unique persistent ID (pID), such as number 12 to be moved from server number 1 to server number 7.

As such, the VM Manager Program 116 (FIG. 1) may migrate the VM assigned a globally unique ID to a second management domain. Therefore, the VM Manager Program 116 (FIG. 1) may receive a target domain to relocate the assigned globally unique ID associated with the VM to be migrated and may assign a unique management ID to the target domain.

Then at 312, the present embodiment looks up the location for the VM with the globally unique ID. Therefore, the VM Manager Program 116 (FIG. 1) may obtain a first management domain and a first domain ID from a database.

According to at least one implementation, the method may also include maintaining at least one second database that may map at least one domain ID to at least one physical server within a group of servers. Additionally, in response to obtaining a domain ID from a global ID to domain ID database, the method may also perform a lookup of the obtained domain ID in the second database, whereby the lookup may be performed optionally after the obtained domain ID has been sent to at least one second server within the group of servers. Furthermore, the method may perform a further lookup of the obtained domain ID in the second database, whereby the further look up may be performed optionally after the obtained domain ID has been sent to at least one second server within the group of servers.

The present embodiment may also include the performance of at least one action on a maintained physical server after the performed action has been issued to a globally unique ID, whereby the globally unique ID has been mapped to the at least one domain ID and whereby the domain ID has been mapped to at least one physical server.

Next at 314, a command is issued to migrate the VM (or unhibernate the VM prior to the migration if the VM is hibernated) using data from the database to target. As such, the VM Manager Program 116 (FIG. 1) may issue a relocation command specifying a ‘from domain’ and a ‘to domain’, and a ‘from domain ID’ and a ‘to domain ID’, indicating that the VM is moving from one physical server (or from storage for a hibernated image) to another physical server.

Then at 316, the database is updated with the location after the migration. Therefore, the VM Manager Program 116 (FIG. 1) may update the database to associate the assigned globally unique ID (corresponding to the migrated virtual machine) with the second management domain and a domain specific VM ID (i.e., the assigned unique management ID). For example, the database may be updated to reflect that VM number 12 is no longer located on physical server number 1, but rather located on physical server number 7.

FIG. 3C illustrates the steps performed when a management action is received according to at least one implementation. At 318, a management command is received for the VM assigned the globally unique ID. As such, the VM Manager Program 116 (FIG. 1) may manage each of the virtual machines assigned each of the globally unique IDs based on receiving a specific management command, such as a command to increase the storage associated with the VM, a command to modify how much memory the VM can use, or a command to shut the VM down.

Then at 320, the method looks up the location for the VM with the globally unique ID. Therefore, the VM Manager Program 116 (FIG. 1) may obtain a management domain and a domain ID from the database based on the globally unique ID assigned to the VM.

Next at 322, a command is issued that performs the management action to the machine and the partition (using the legacy machine or the partition interface). As such, the VM Manager Program 116 (FIG. 1) may issue a command to a control node for a returned domain, whereby the command includes receiving a domain ID uniquely identifying the virtual machine associated with the domain.

FIG. 3D illustrates the steps performed during a self-identify action according to at least one implementation. At 324, the method receives a request to identify the current partition. As such, the VM has the ability to identify the globally unique ID associated with it. Then at 326, the method obtains the current partition for the local immutable property. As such, the VM Manager Program 116 (FIG. 1) may be able to retrieve the globally unique ID from the VM.

According to at least one implementation, the present embodiment has the additional capability of performing a domain load balancing for multiple domains. As such, the VM Manager Program 116 (FIG. 1) may identify an aggregate load level for at least one domain within a group of domains. Then, the method may determine a target load level for each domain. Next, the method may determine a contribution factor for each partition within a plurality of partitions associated with the database based on a domain utilization.

Then, the method may determine to move at least one virtual machine between at least two domains within the group of domains to reach a target load level, whereby the determination includes optionally selecting service level agreements (SLAs) to determine the virtual machine to be moved. Next, the VM Manager Program 116 (FIG. 1) may migrate the group of virtual machines from a first current domain to a second domain. Then the VM Manager Program 116 (FIG. 1) may update the database with the unique ID corresponding to each of the migrated virtual machines, a name associated with the second domain, and the domain ID corresponding to the second domain.

Additionally, according to at least one implementation, the method may hibernate a uniquely identified virtual machine. As such, the VM Manager Program 116 (FIG. 1) may determine a domain associated with the hibernated uniquely identified virtual machine and a domain specific virtual machine ID. Then, the VM Manager Program 116 (FIG. 1) may issue commands to stop at least one virtual machine and store an image associated with the stopped virtual machine to an image file location. Next, the VM Manager Program 116 (FIG. 1) may store a hibernation indication and the image file location in at least one database.

Furthermore, the hibernation may be indicated using a domain reflective of hibernation and a hibernation-domain ID corresponding to the image file location. The hibernation may include an optional indication that the hibernation as a partition has moved to the hibernation domain. The method may also include an optional indication that an unhibernation as a partition has moved from the hibernation domain.

It may be appreciated that FIGS. 3A-3D provide only an illustration of one implementation and does not imply any limitations with regard to how different embodiments may be implemented. Many modifications to the depicted environments may be made based on design and implementation requirements. For example, as previously described with respect to an alternate implementation, the unique persistent ID may be created by being randomly generated, by combining server IDs, or by using the hostname. Also, the unique pID is a property of VM and not its physical surroundings. Therefore, as previously described, the unique pID is independent of a data center, a cluster, or a server. The present embodiment may allow for mapping of a VM to its physical location performed based on the pID. As such, there is no need to modify the pID when migrating a VM from one server to another as in Live Partition Migration or Remote Restart. Furthermore, there is no need to modify the pID when migrating a VM from one data center to another as in disaster recovery. Also, there is no need to track pID under failure modes that may change it (i.e., path-dependence).

An advantage of the present embodiment may include a simplified implementation of the tools stack. Additionally, the present embodiment may allow for the continuous tracking of a VM, including the VMs whereabouts and the VMs properties. Furthermore, the present embodiment may be utilized as enablement technology for high availability/disaster recovery (HA/DR).

FIG. 4 is a block diagram 400 of internal and external components of computers depicted in FIG. 1 in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 (FIG. 1) and network server 114 (FIG. 1) may include respective sets of internal components 800 a,b and external components 900 a,b illustrated in FIG. 4. Each of the sets of internal components 800 include one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and the Software Program 108 (FIG. 1) in client computer 102 (FIG. 1) and the VM Manager Program 116 (FIG. 1) in network server 114 (FIG. 1) are stored on one or more of the respective computer-readable tangible storage devices 830 for execution by one or more of the respective processors 820 via one or more of the respective RAMs 822 (which typically include cache memory). In the embodiment illustrated in FIG. 4, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 a,b also includes a R/W drive or interface 832 to read from and write to one or more portable computer-readable tangible storage devices 936 such as a CD-ROM, DVD, memory stick, magnetic tape, magnetic disk, optical disk or semiconductor storage device. A software program, such as the Software Program 108 (FIG. 1) and the VM Manager Program 116 (FIG. 1) can be stored on one or more of the respective portable computer-readable tangible storage devices 936, read via the respective R/W drive or interface 832 and loaded into the respective hard drive 830.

Each set of internal components 800 a,b also includes network adapters or interfaces 836 such as a TCP/IP adapter cards, wireless Wi-Fi interface cards, or 3G or 4G wireless interface cards or other wired or wireless communication links. The Software Program 108 (FIG. 1) in client computer 102 (FIG. 1) and the VM Manager Program 116 (FIG. 1) in network server 114 (FIG. 1) can be downloaded to client computer 102 (FIG. 1) and network server 114 (FIG. 1) from an external computer via a network (for example, the Internet, a local area network or other, wide area network) and respective network adapters or interfaces 836. From the network adapters or interfaces 836, the Software Program 108 (FIG. 1) in client computer 102 (FIG. 1) and the VM Manager Program 116 (FIG. 1) in network server 114 (FIG. 1) is loaded into the respective hard drive 830. The network may comprise copper wires, optical fibers, wireless transmission, routers, firewalls, switches, gateway computers and/or edge servers.

Each of the sets of external components 900 a,b can include a computer display monitor 920, a keyboard 930, and a computer mouse 934. External components 900 a,b can also include touch screens, virtual keyboards, touch pads, pointing devices, and other human interface devices. Each of the sets of internal components 800 a,b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

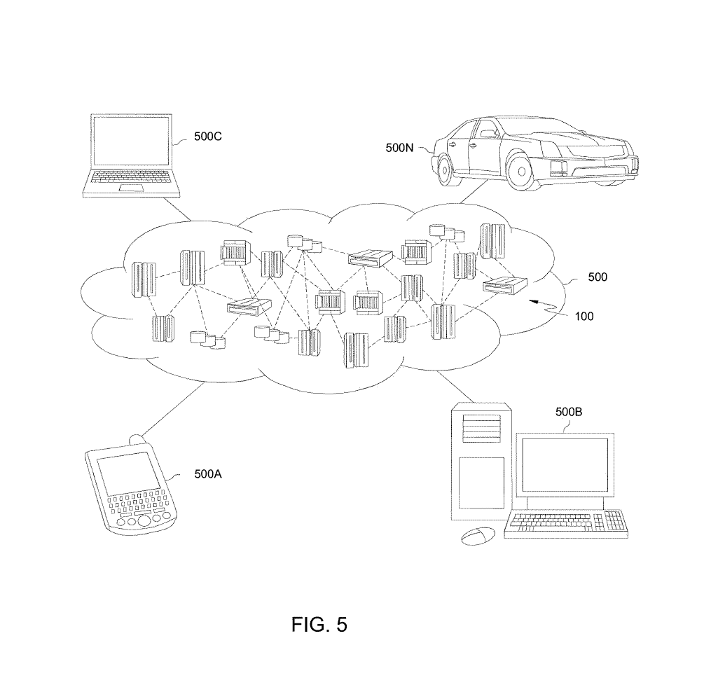

Referring now to FIG. 5, illustrative cloud computing environment 500 is depicted. As shown, cloud computing environment 500 comprises one or more cloud computing nodes 100 with which local computing devices used by cloud consumers, such as, for example, personal digital assistant (PDA) or cellular telephone 500A, desktop computer 500B, laptop computer 500C, and/or automobile computer system 500N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 500 to offer infrastructure, platforms and/or software as services for which a cloud consumer does not need to maintain resources on a local computing device. It is understood that the types of computing devices 500A-N shown in FIG. 5 are intended to be illustrative only and that computing nodes 100 and cloud computing environment 500 can communicate with any type of computerized device over any type of network and/or network addressable connection (e.g., using a web browser).

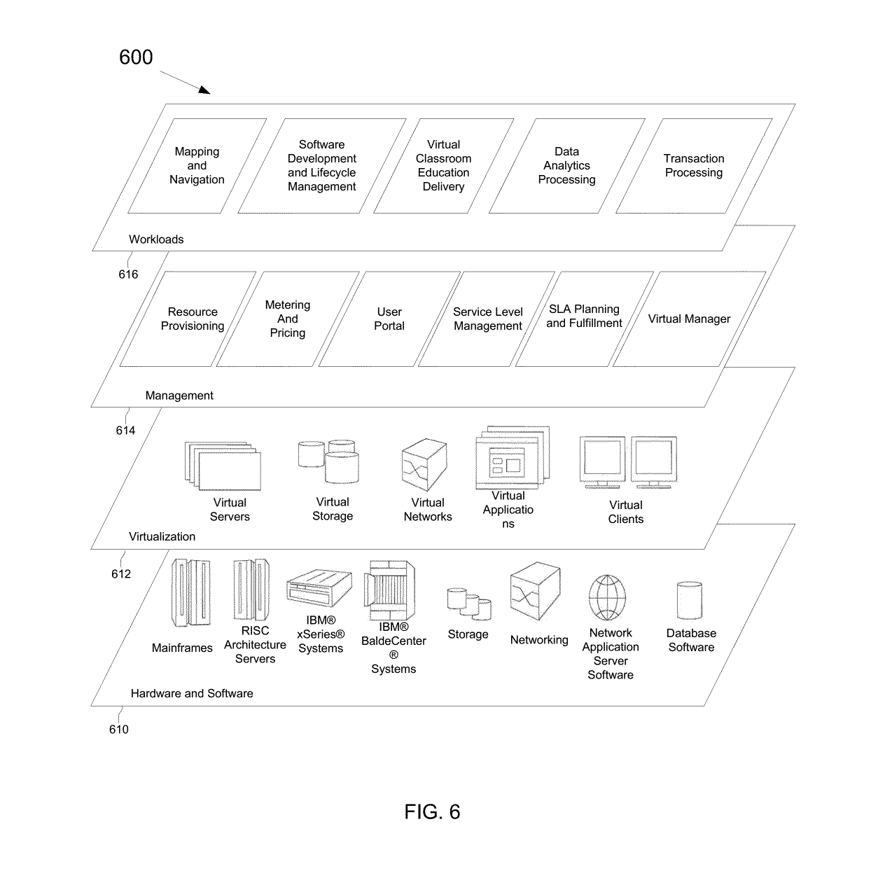

Referring now to FIG. 6, a set of functional abstraction layers 600 provided by cloud computing environment 500 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 610 includes hardware and software components. Examples of hardware components include: mainframes; RISC (Reduced Instruction Set Computer) architecture based servers; storage devices; networks and networking components. In some embodiments, software components include network application server software.

Virtualization layer 612 provides an abstraction layer from which the following examples of virtual entities may be provided: virtual servers; virtual storage; virtual networks, including virtual private networks; virtual applications and operating systems; and virtual clients.

In one example, management layer 614 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA. A virtual manager program provides a remote backup system (RBS) for managing VMs using persistent unique VM IDs.

Workloads layer 616 provides examples of functionality for which the cloud computing environment may be utilized. Examples of workloads and functions which may be provided from this layer include: mapping and navigation; software development and lifecycle management; virtual classroom education delivery; data analytics processing; and transaction processing.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for identifying and managing a plurality of virtual machines, the method comprising:
creating a virtual machine within the plurality of virtual machines;
creating a plurality of globally unique IDs for each virtual machine within the plurality of virtual machines, wherein the plurality of globally unique IDs is created by being randomly generated, by combining a plurality of server IDs, or by using a hostname, and wherein the plurality of globally unique IDs is independent of a data center, a cluster, and a server;
assigning each of the globally unique IDs within the plurality of globally unique IDs to each of the virtual machines within the plurality of virtual machines, wherein the assigned globally unique ID is assigned to only one virtual machine;
recording each globally unique ID into at least one database; and
associating the recorded globally unique ID with a management domain corresponding to the virtual machine assigned the globally unique ID, and a domain ID corresponding to the virtual machine.

2. The method of claim 1, further comprising:
binding the globally unique ID to an existing resource associated with the virtual machine assigned the globally unique ID, the unused resource is not reflective of the globally unique ID and wherein the existing resource is optionally an unused fibre channel port, and optionally further comprising providing a means to determine a globally unique ID of a virtual machine by querying a resource associated with the virtual machine assigned the globally unique ID.

3. The method of claim 2, wherein the globally unique ID can be assigned and queried in a legacy virtual machine environment not designed to support the assigning of the globally unique ID.

4. The method of claim 1, further comprising:
managing each of the virtual machines assigned each of the globally unique IDs, wherein the managing of the virtual machines further comprises:
specifying a management command and the assigned globally unique ID;
obtaining a management domain and a domain ID from the at least one database; and
issuing a command to a control node for a returned domain, wherein the command comprises receiving a domain ID uniquely identifying at least one managed virtual machine within the obtained management domain.

5. The method of claim 1, further comprising:
migrating at least one virtual machine associated with at least one of the assigned globally unique IDs to a second management domain, wherein the migrating further comprises:
receiving a target domain to which to relocate the at least one virtual machine corresponding to the globally unique ID;
obtaining a unique management ID in the target domain, wherein the obtained unique management ID is a domain-specific VM ID;
obtaining a first management domain and a first domain ID from the at least one database;
issuing a relocation command specifying a from-domain and a to-domain, and a VM ID in the from-domain and a VM ID in the to-domain; and
updating the at least one database to associate the assigned globally unique ID corresponding to the at least one migrated virtual machine with the second management domain and the domain-specific VM ID.

6. The method of claim 1, further comprising:
hibernating a uniquely identified virtual machine;
determining a domain associated with the hibernated uniquely identified virtual machine and a domain specific virtual machine ID associated with the hibernated uniquely identified virtual machine;
issuing a plurality of commands to stop at least one virtual machine and store an image associated with the at least one stopped virtual machine to an image file location; and
storing a hibernation indication and the image file location in at least one database.

7. The method of claim 6, wherein the hibernation is indicated using a domain reflective of hibernation and a hibernation-domain ID corresponding to the image file location and wherein the hibernation further comprises:
including an optional indication that the hibernated partition as a partition has moved to the hibernation domain.

8. The method of claim 1, further comprising:
performing a domain load balancing for a plurality of domains;
identifying an aggregate load level for at least one domain within the plurality of domains;
determining a target load level for each domain within the plurality of domains;
determining a contribution factor for each partition within a plurality of partitions associated with the at least one database based on a domain utilization;
determining to move at least one virtual machine between at least two domains within the plurality of domains to reach a target load level, wherein the determination comprises optionally selecting service level agreements (SLAs) to determine the at least one virtual machine to be moved;
migrating the plurality of virtual machines from a first current domain to a second domain; and
updating the at least one database with the unique ID corresponding to each of the migrated virtual machines within the at least one moved virtual machines, a name associated with the second domain, and the domain ID corresponding to the determined second domain.

9. The method of claim 1 further comprising:
maintaining at least one second database within a plurality of second databases, wherein the second database maps at least one domain ID to at least one physical server within a plurality of servers;
responsive to obtaining a domain ID from a global ID to domain ID database, performing a lookup of the obtained domain ID in the maintained at least one second database, wherein the lookup is performed optionally after the obtained domain id has been sent to at least one second server within the plurality of servers; and
performing a further lookup of the obtained domain id in the at least one maintained second database within the plurality of maintained second databases, wherein the further look up is performed optionally after the obtained domain ID has been sent to at least one second server within the plurality of servers.

10. The method of claim 9, further comprising:
performing at least one action on the at least one maintained physical server within the plurality of servers after the performed action has been issued to a globally unique ID, wherein the globally unique ID has been mapped to the at least one domain ID, wherein the domain ID has been mapped to the at least one physical server within the plurality of servers.

11. A computer system for identifying and managing a plurality of virtual machines, the computer system comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
creating a virtual machine within the plurality of virtual machines;
creating a plurality of globally unique IDs for each virtual machine within the plurality of virtual machines, wherein the plurality of globally unique IDs is created by being randomly generated, by combining a plurality of server IDs, or by using a hostname, and wherein the plurality of globally unique IDs is independent of a data center, a cluster, and a server;
assigning each of the globally unique IDs within the plurality of globally unique IDs to each of the virtual machines within the plurality of virtual machines, wherein the assigned globally unique ID is assigned to only one virtual machine;
recording each globally unique ID into at least one database; and
associating the recorded globally unique ID with a management domain corresponding to the virtual machine assigned the globally unique ID, and a domain ID corresponding to the virtual machine.

12. The computer system of claim 11, further comprising:
binding the globally unique ID to an existing resource associated with the virtual machine assigned the globally unique ID, wherein the existing resource is an unused fibre channel port and the unused resource is not reflective of the globally unique ID, and optionally further comprising providing a means to determine a globally unique ID of a virtual machine by querying a resource associated with the virtual machine assigned the globally unique ID.

13. The computer system of claim 12, wherein the globally unique ID can be assigned and queried in a legacy virtual machine environment not designed to support the assigning of the globally unique ID.

14. The computer system of claim 11, further comprising:
managing each of the virtual machines assigned each of the globally unique IDs, wherein the managing of the virtual machines further comprises:
specifying a management command and the assigned globally unique ID;
obtaining a management domain and a domain ID from the at least one database; and
issuing a command to a control node for a returned domain, wherein the command comprises receiving a domain ID uniquely identifying at least one managed virtual machine within the obtained management domain.

15. The computer system of claim 11, further comprising:
migrating at least one virtual machine associated with at least one of the assigned globally unique IDs to a second management domain, wherein the migrating further comprises:
receiving a target domain to which to relocate the at least one virtual machine corresponding to the globally unique ID;
obtaining a unique management ID in the target domain, wherein the obtained unique management ID is a domain-specific VM ID;
obtaining a first management domain and a first domain ID from the at least one database;
issuing a relocation command specifying a from-domain and a to-domain, and a VM ID in the from-domain and a VM ID in the to-domain; and
updating the at least one database to associate the assigned globally unique ID corresponding to the at least one migrated virtual machine with the second management domain and the domain-specific VM ID.

16. The computer system of claim 11, further comprising:
hibernating a uniquely identified virtual machine;
determining a domain associated with the hibernated uniquely identified virtual machine and a domain specific virtual machine ID associated with the hibernated uniquely identified virtual machine;
issuing a plurality of commands to stop at least one virtual machine and store an image associated with the at least one stopped virtual machine to an image file location; and
storing a hibernation indication and the image file location in at least one database.

17. The computer system of claim 16, wherein the hibernation is indicated using a domain reflective of hibernation and a hibernation-domain ID corresponding to the image file location and wherein the hibernation further comprises:
including an optional indication that the hibernation as a partition has moved to the hibernation domain.

18. The computer system of claim 11, further comprising:
performing a domain load balancing for a plurality of domains;
identifying an aggregate load level for at least one domain within the plurality of domains;
determining a target load level for each domain within the plurality of domains;
determining a contribution factor for each partition within a plurality of partitions associated with the at least one database based on a domain utilization;
determining to move at least one virtual machine between at least two domains within the plurality of domains to reach a target load level, wherein the determination comprises optionally selecting service level agreements (SLAs) to determine the at least one virtual machine to be moved;
migrating the plurality of virtual machines from a first current domain to a second domain; and
updating the at least one database with the unique ID corresponding to each of the migrated virtual machines within the at least one moved virtual machines, a name associated with the second domain, and the domain ID corresponding to the determined second domain.

19. A computer program product for identifying and managing a plurality of virtual machines, the computer program product comprising:
one or more computer-readable storage devices and program instructions stored on at least one of the one or more tangible storage devices, the program instructions executable by a processor, the program instructions comprising:
program instructions to create a virtual machine within the plurality of virtual machines;
program instructions to create a plurality of globally unique IDs for each virtual machine within the plurality of virtual machines, wherein the plurality of globally unique IDs is created by being randomly generated, by combining a plurality of server IDs, or by using a hostname, and wherein the plurality of globally unique IDs is independent of a data center, a cluster, and a server;
program instructions to assign each of the globally unique IDs within the plurality of globally unique IDs to each of the virtual machines within the plurality of virtual machines, wherein the assigned globally unique ID is assigned to only one virtual machine;
program instructions to record each globally unique ID into at least one database; and
program instructions to associate the recorded globally unique ID with a management domain corresponding to the virtual machine assigned the globally unique ID, and a domain ID corresponding to the virtual machine.

20. The computer program product of claim 19, further comprising:
binding the globally unique ID to an existing resource associated with the virtual machine assigned the globally unique ID, wherein the existing resource is an unused fibre channel port and the unused resource is not reflective of the globally unique ID, and optionally further comprising providing a means to determine a globally unique ID of a virtual machine by querying a resource associated with the virtual machine assigned the globally unique ID.
